(19) United States
(12) Patent Application Publication
(10) Pub. No.: US 2021/0224896 A1
(43) Pub. Date: Jul. 22, 2021

(54) INFORMATION PROCESSING METHOD, INFORMATION PROCESSING APPARATUS, STORAGE MEDIUM, AND INFORMATION PROCESSING TERMINAL

(71) Applicant: MERCARI, INC., Tokyo (JP)

(72) Inventor: Keita NAKAMURA, Tokyo (JP)

(21) Appl. No.: 17/146,228

(22) Filed: Jan. 11, 2021

(30) Foreign Application Priority Data
Jan. 17, 2020 (JP) 2020-006322

(51) Int. Cl. G06Q 40/02; G06Q 30/06; G06F 3/0482

(52) U.S. Cl. CPC G06Q 40/02; G06F 3/0482; G06Q 30/06

(57) ABSTRACT

A method performed by an information processing apparatus includes when settlement of a debt of a user is delayed, determining a display mode of a first object based on at least one of a degree of delay from a settlement deadline of the debt of the user, an amount of the debt whose settlement is delayed by the user, and a credit of the user; and sending, to an information processing terminal, information for causing the information processing terminal to display the first object in the determined display mode.

### CROSS-REFERENCE TO RELATED APPLICATION

The present application is based upon and claims priority to Japanese Patent Application No. 2020-006322, filed on Jan. 17, 2020, the entire contents of which are incorporated herein by reference.

### FIELD OF THE TECHNOLOGY

An aspect of this disclosure relates to an information processing method, an information processing apparatus, a storage medium, and an information processing terminal.

### BACKGROUND

Japanese unexamined Patent Application Publication No. 2005-056211, for example, discloses a technology that enables credit settlement (payment or repayment) using multiple types of deferred payment methods such as installment plans (e.g., revolving payment and installment payment) and lump-sum payment.

However, with the related-art technology, inconvenience may occur in settling debt by, for example, deferred payment.

### SUMMARY

In an aspect of this disclosure, there is provided a method performed by an information processing apparatus. The method includes when settlement of a debt of a user is delayed, determining a display mode of a first object based on at least one of a degree of delay from a settlement deadline of the debt of the user, an amount of the debt whose settlement is delayed by the user, and a credit of the user, and sending, to an information processing terminal, information for causing the information processing terminal to display the first object in the determined display mode.

### BRIEF DESCRIPTION OF THE DRAWINGS

FIG. 1 is a drawing illustrating a configuration of a communication system according to an embodiment;

FIG. 2 is a drawing illustrating an example of a hardware configuration of an information processing apparatus according to the embodiment;

FIG. 3 is a drawing illustrating examples of configurations of a server and a terminal according to the embodiment;

FIG. 4 is a sequence chart illustrating an example of a process performed by a communication system according to the embodiment;

FIG. 5A is a table illustrating an example of user information stored in a user information storage according to the embodiment;

FIG. 5B is a table illustrating an example of deferred payment information stored in a deferred payment information storage according to the embodiment;

FIG. 6 is a drawing illustrating an example of a display screen of a terminal according to the embodiment;

FIG. 7A is a drawing illustrating an example of a display screen of a terminal according to the embodiment;

FIG. 7B is a drawing illustrating an example of a display screen of a terminal according to the embodiment; and

FIG. 7C is a drawing illustrating an example of a display screen of a terminal according to the embodiment.

### DESCRIPTION OF EMBODIMENTS

The disclosure of the present application shall be implemented in compliance with the laws and regulations of each country where the disclosure is implemented. Also, the disclosure of the present application may be implemented by applying all modifications, substitutions, transformations, alterations, and corrections that are necessary to comply with the laws and regulations of each country and can be performed by a person skilled in the art.

An aspect of this disclosure provides a technology that can improve the convenience in settling debt incurred as a result of deferred payment or a loan. Embodiments of this disclosure for implementing processes for providing services such as deferred payment and loans are described below with reference to the accompanying drawings.

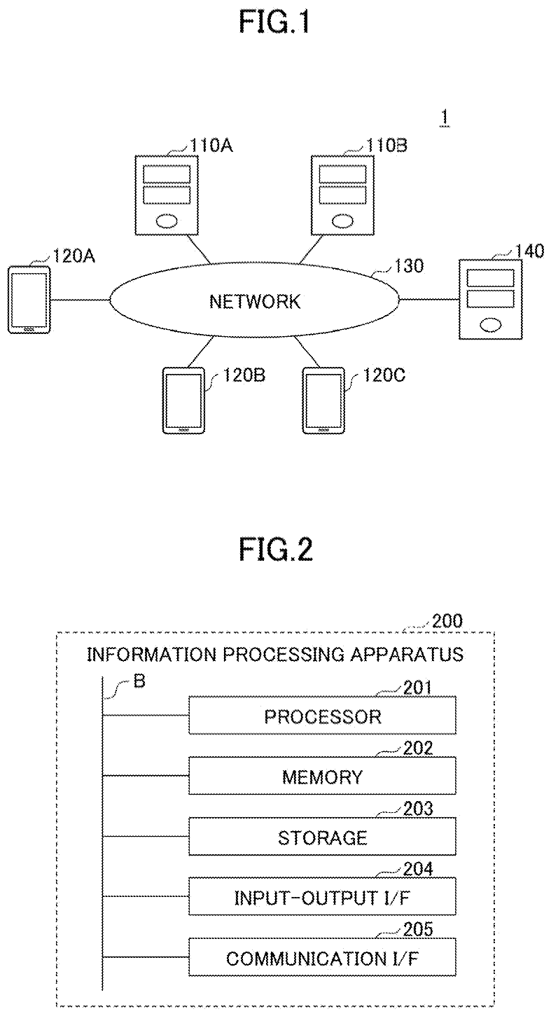

FIG. 1 is a drawing illustrating a configuration of a communication system 1 according to an embodiment. As illustrated in FIG. 1, the communication system 1 includes a server 110A, a server 110B, a terminal 120A, a terminal 120B, a terminal 120C, and a financial institution server 140 that are connected to each other via a network 130.

In this disclosure, when it is not necessary to distinguish between the server 110A and the server 110B, each of the server 110A and the server 110B may be referred to as a server 110. The server 110 is an example of an “information processing apparatus”.

In this disclosure, when it is not necessary to distinguish between the terminal 120A, the terminal 120B, and the terminal 120C, each of the terminal 120A, the terminal 120B, and the terminal 120C may be referred to as a terminal 120 (an example of an “information processing terminal”). The numbers of the servers 110, the terminals 120, and the financial institution server 140 are not limited to the example of FIG. 1.

In this disclosure, when it is not necessary to distinguish between the server 110 and the terminal 120, each of the server 110 and the terminal 120 may be referred to as an information processing apparatus 200. The number of the information processing apparatuses 200 connected to the network 130 is not limited to the example of FIG. 1.

The server 110 provides predetermined services to the terminal 120 used by a user via the network 130. The predetermined services include, for example, but are not limited to, settlement services, financial services, electronic commerce services, social networking services (SNS) such as a messaging service using an instant messenger, and content providing services for providing contents such as music, videos, and books (including comics). The settlement services may include, for example, a settlement service using a two-dimensional code and near-field radio communication. The settlement services may also include a deferred payment service by credit (loan).

The electronic commerce services (transaction services) may include, for example, an Internet mail order service, an interpersonal transaction service such as a flea market service or an online auction service, and an immediate purchase (pawn shop) service. When users use predetermined services via the terminals 120, the server 110 can provide the predetermined services to one or more terminals 120.

The terminal 120 is, for example, a smartphone, a tablet, or a personal computer used by the user and performs processes to use various services provided by the server 110.

The financial institution server 140 is a server run by a financial institution that handles deposits and savings. Examples of financial institutions include a bank (ordinary bank) that is a cooperation having a license to run a bank business according to the bank law and a cooperative financial institution that is a cooperative depository institution. The financial institution server 140 manages deposit accounts such as bank accounts of users. When money is deposited into a deposit account of a user via an online transaction such as Internet banking or an automated teller machine (ATM), the financial institution server 140 may transfer the money into the deposit account of the user. Also, the financial institution server 140 may transfer money into a deposit account of a user when, for example, the money is transferred from another financial account of the same user to the deposit account.

As necessary, a terminal used by a user X is referred to as a terminal 120X, and user information in a predetermined service associated with the user X or the terminal 120X is referred to as user information X. Here, user information is information on a user and associated with an account used by the user in a predetermined service. As a non-limiting example, user information may include one or more of a name of a user entered by the user or assigned by the predetermined service, an icon image of the user, the age of the user, the gender of the user, the address of the user, hobbies and tastes of the user, information such as a user identifier associated with the user, balance information of an electronic value (electronic money) associated with the user, and credit card information (e.g., a credit card number) associated with the user.

The network 130 connects two or more information processing apparatuses 200 to each other. The network 130 indicates a communication network that provides a connection path to enable the terminal 120 to send and receive data after being connected to the server 110.

One or more parts of the network 130 may be a wired network or a wireless network. As non-limiting examples, the network 130 may include one or more of an ad-hoc network, an intranet, an extranet, a virtual private network (VPN), a local area network (LAN), a wireless LAN (WLAN), a wide area network (WAN), a wireless WAN (WWAN), a metropolitan area network (MAN), a part of the Internet, a part of a public switched telephone network (PSTN), a mobile network, an integrated service digital network (ISDN), a Wi-Fi network, a Long Term Evolution (LTE) network, a Code Division Multiple Access (CDMA) network, a Bluetooth (registered trademark) network, and a satellite communication network. The network 130 may include one or more networks.

The information processing apparatus 200 may be implemented by any type of information processing apparatus as long as processes, functions, and methods described in this disclosure can be implemented.

Examples of the information processing apparatuses 200 include, but are not limited to, a smartphone, a mobile phone (feature phone), computers (e.g., a desktop computer, a laptop computer, and a tablet computer), a server apparatus, media computer platforms (e.g., a cable set top box, a satellite set top box, and a digital video recorder), handheld computer devices (e.g., a personal digital assistant (PDA) and an email client), wearable terminals (e.g., a glass-type device and a clock-type device), other types of computers, and communication platforms.

A hardware configuration of the information processing apparatus 200 included in the communication system 1 is described with reference to FIG. 2. FIG. 2 is a drawing illustrating an example of a hardware configuration of the information processing apparatus 200 according to the embodiment.

The information processing apparatus 200 includes a processor 201, a memory 202, a storage 203, an input-output interface (input-output I/F) 204, and a communication interface (communication I/F) 205. As a non-limiting example, the hardware components of the information processing apparatus 200 are connected to each other via a bus B.

The information processing apparatus 200 implements processes, functions, and/or methods described in this disclosure through collaboration of the processor 201, the memory 202, the storage 203, the input-output I/F 204, and the communication I/F 205.

The processor 201 performs processes, functions, and methods according to codes or instructions included in programs stored in the storage 203. The processor 201 may be implemented by, for example, but is not limited to, a central processing unit (CPU), a micro processing unit (MPU), a graphics processing unit (GPU), a microprocessor, a processor core, a multiprocessor, an application specific integrated circuit (ASIC), or a field programmable gate array (FPGA). Also, processes described in the embodiments may be implemented by logic circuits (hardware) or dedicated circuits formed in an integrated circuit (e.g., an integrated circuit (IC) chip or a large scale integration (LSI) circuit). These circuits may be implemented by one or more integrated circuits, and multiple processes described in the embodiments may be implemented by one integrated circuit. An LSI circuit may be referred to as a VLSI circuit, a super LSI circuit, or an ultra LSI circuit depending on the degree of integration.

The memory 202 temporarily stores a program loaded from the storage 203 and provides a work area for the processor 201. The memory 202 also temporarily stores various types of data generated while the processor 201 is executing the program. As a non-limiting example, the memory 202 includes a random access memory (RAM) and a read-only memory (ROM).

The storage 203 stores programs. As a non-limiting example, the storage 203 may be implemented by a hard disk drive (HDD), a solid state drive (SSD), and/or a flash memory.

The communication I/F 205 sends and receives various types of data via the network 130. The communication I/F may perform wired communications and/or wireless communications, and may use any communication protocol as long as communications with other information processing apparatuses can be performed. The communication I/F 205 communicates with other information processing apparatuses via the network 130. The communication I/F 205 sends various types of data to other information processing apparatuses according to instructions from the processor 201. Also, the communication I/F 205 receives various types of data sent from other information processing apparatuses and transfers the received data to the processor 201.

The input-output I/F 204 includes an input device for inputting various operations to the information processing apparatus 200 and an output device for outputting results of processes performed by the information processing apparatus 200. In the input-output I/F 204, the input device and the output device may be integrated or may be provided as separate components.

The input device may be implemented by one or more of all types of devices that can receive inputs from the user and send information related to the inputs to the processor 201. The input device may be implemented by, for example, but is not limited to, a touch panel, a touch display, hardware keys such as a keyboard, a pointing device such as a mouse, a camera (for inputting an operation via an image), and/or a microphone (for inputting an operation via voice).

The output device may be implemented by one or more of all types of devices that can output results of processes performed by the processor 201. When the results of processes are to be output as images or videos, the output device may be implemented by one or more of all types of devices capable of displaying display data written into a frame buffer. The output device may be implemented by, for example, but is not limited to, a touch panel, a touch display, a monitor (e.g., a liquid crystal display or an organic electroluminescence display (OELD)), a head mounted display (HMD), a projection mapping system, a hologram device, a device that can display, for example, images and text information in the air (or in vacuum), a speaker (audio output), and/or a printer. The output device may be capable of displaying display data in three dimensions.

The program of the embodiment of this disclosure may be stored in and provided via a non-transitory and tangible computer-readable storage medium. The program may be, for example, but is not limited to, a software program or a computer program.

The storage medium may be implemented by, for example, but is not limited to, one or more semiconductor-based or other types of integrated circuits (IC) (e.g., a field programmable gate array (FPGA) and an application-specific IC (ASIC)), a hard disk drive (HDD), a hybrid hard drive (HHD), an optical disk, an optical disk drive (ODD), a magneto optical disk, a magneto optical drive, a floppy diskette, a floppy disk drive (FDD), a magnetic tape, a solid state drive (SSD), a RAM drive, a secure digital card, a secure digital drive, any other suitable storage medium, or a combination of them. The storage medium may be a volatile storage medium, a non-volatile storage medium, or a combination of a volatile storage medium and a non-volatile storage medium.

Also, the program of this disclosure may be provided to the information processing apparatus 200 via a transmission medium (e.g., a communication network or airwaves) capable of transmitting the program.

The program of the embodiment of this disclosure may also be implemented by electronic transmission, i.e., in the form of a data signal embedded in a carrier wave.

As a non-limiting example, the program of this disclosure may be written in a scripting language such as JavaScript (registered trademark) or Python, the C language, the Go language, Swift, Kotlin, or Java (registered trademark).

At least a part of the processes performed by the information processing apparatus 200 may be implemented by cloud computing provided by one or more computers.

At least a part of the processes performed by the information processing apparatus 200 may be performed by another information processing apparatus. In this case, at least a part of processes performed by units implemented by the processor 201 may be performed by another information processing apparatus.

Unless explicitly mentioned, a decision configuration in the embodiment of this disclosure is not essential. For example, a predetermined process may be performed when a decision condition is satisfied, or a predetermined process may be performed when a decision condition is not satisfied.

This disclosure encompasses all modifications, substitutions, transformations, alterations, and corrections that can be performed by a person skilled in the art on the embodiments and examples of this disclosure. Also, the claims encompass all modifications, substitutions, transformations, alterations, and corrections that can be performed by a person skilled in the art on the embodiments and examples of this disclosure. Further, this disclosure encompasses any combination, which can be performed by a person skilled in the art, of one or more features in an embodiment or an example of this disclosure and one or more features in another embodiment or another example of this disclosure.

Further, a reference in the claims to an apparatus, a system, or a component of the apparatus or the system that is adapted, arranged, capable, configured, usable, operational, or movable to perform a specific process, function, or method encompasses the apparatus, the system, or the component regardless of whether the apparatus, the system, the component, or the specific function is activated, turned on, or unlocked as long as the apparatus, the system, or the component is adapted, arranged, capable, configured, usable, operational, or movable to perform the specific process, function, or method.

Unless otherwise mentioned, this disclosure may obtain consent from the user before or immediately before implementing an embodiment or an example. The consent may be obtained as comprehensive consent or may be obtained each time.

In an embodiment of this disclosure, settlement of a deferred payment service is performed. The embodiment makes it possible to improve the convenience in settling debt incurred as a result of, for example, deferred payment or a loan. Also, for example, because the embodiment enables settling deferred payment in an appropriate manner, the embodiment also makes it possible to reduce the load of the terminal 120A and the server 110 and the load of the network 130 between the terminal 120A and the server 110.

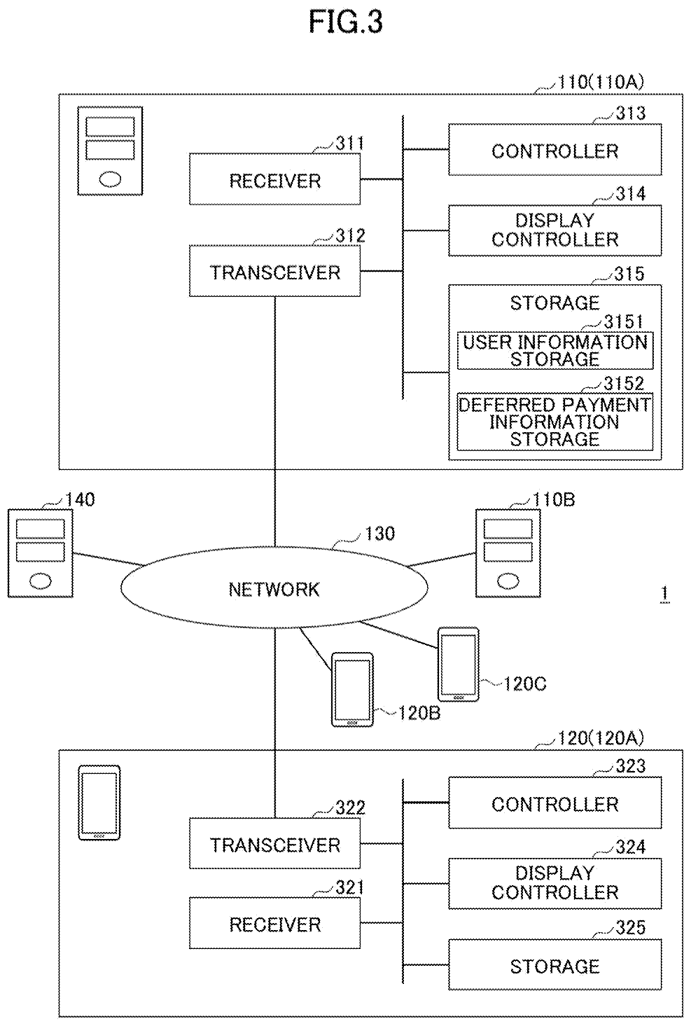

Configurations of the server 110 and the terminal 120 are described with reference to FIG. 3. FIG. 3 is a drawing illustrating examples of configurations of the server 110 and the terminal 120 according to the embodiment. Components illustrated in FIG. 3 are implemented by collaboration among the processor 201, the memory 202, the storage 203, the input-output I/F 204, and the communication I/F 205 of the information processing apparatus 200.

The server 110 includes a receiver 311, a transceiver 312, a controller 313, a display controller 314, and a storage 315. To the extent feasible, processes, functions, or methods performed by these components may be implemented by using machine learning or artificial intelligence (AI).

The receiver 311 receives, for example, various setting operations from a business operator that operates various services provided by the server 110.

The transceiver 312 sends and receives data to and from the terminal 120 according to instructions from the controller 313. For example, when the user of the terminal 120 is authenticated based on a user ID and a password included in a login request from the terminal 120, the transceiver 312 establishes a communication session using HTTPS with the terminal 120. The transceiver 312 stores, for example, a communication address of the terminal 120 and the user ID in association with an ID of the established communication session. Then, the transceiver 312 sends data to the terminal 120 using the established communication session.

The controller 313 performs processes for providing various services such as an electronic commerce service and a settlement service to the user of the terminal 120.

The display controller 314 causes the transceiver 312 to send information for controlling the display screen of the terminal 120 according to an instruction from the controller 313.

The storage 315 includes a user information storage 3151 for storing user information and a deferred payment information storage 3152 for storing deferred payment information.

The terminal 120 includes a receiver 321, a transceiver 322, a controller 323, a display controller 324, and a storage 325. To the extent feasible, processes, functions, or methods performed by these components may be implemented by using machine learning or artificial intelligence (AI).

The receiver 321 receives various operations from the user of the terminal 120.

The transceiver 322 sends and receives data to and from the server 110 according to instructions from the controller 323. For example, when the terminal 120 logs into the server 110, the transceiver 322 establishes a communication session using HTTPS with the server 110. The transceiver 322 stores, for example, the communication address of the server 110 in association with an ID of the established communication session. Then, the transceiver 322 sends data to the server 110 using the established communication session.

The controller 323 performs processes for using various services provided by the server 110. The display controller 324 controls the display screen of the terminal 120 based on information received from the server 110 according to instructions from the controller 323. The storage 325, for example, stores information for using services provided by the server 110.

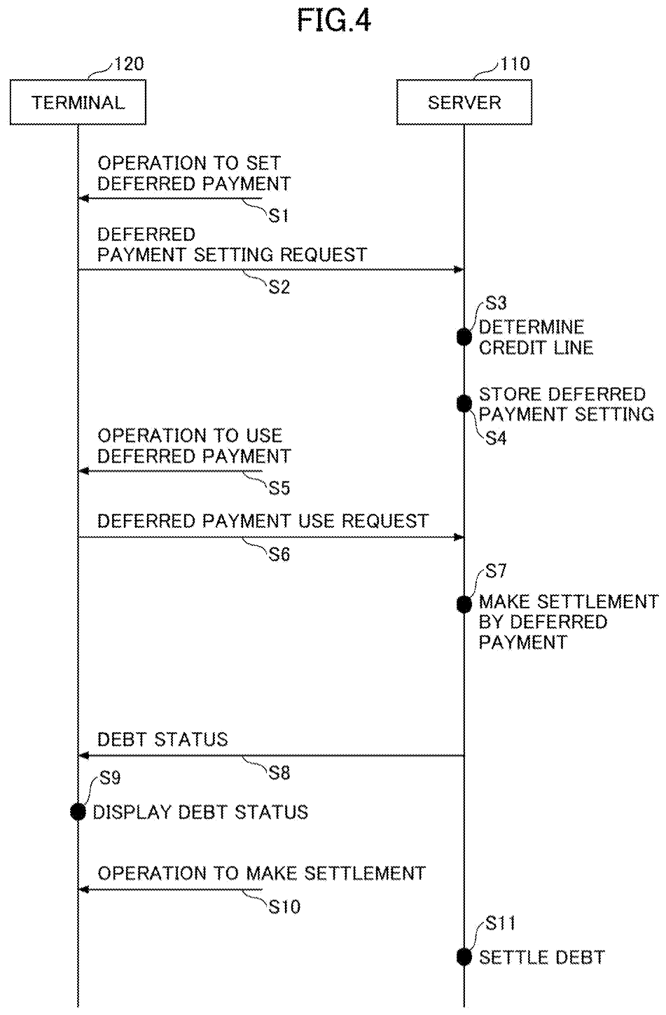

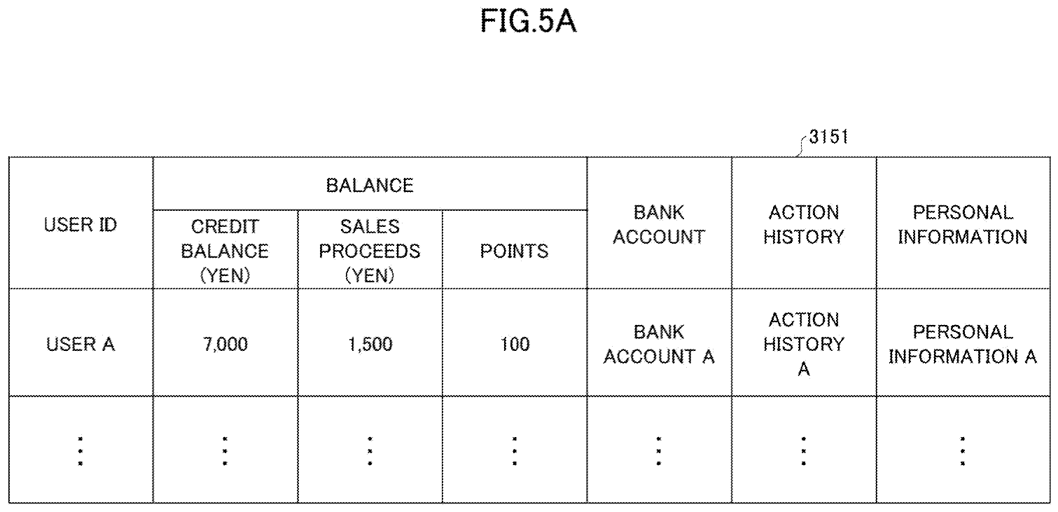

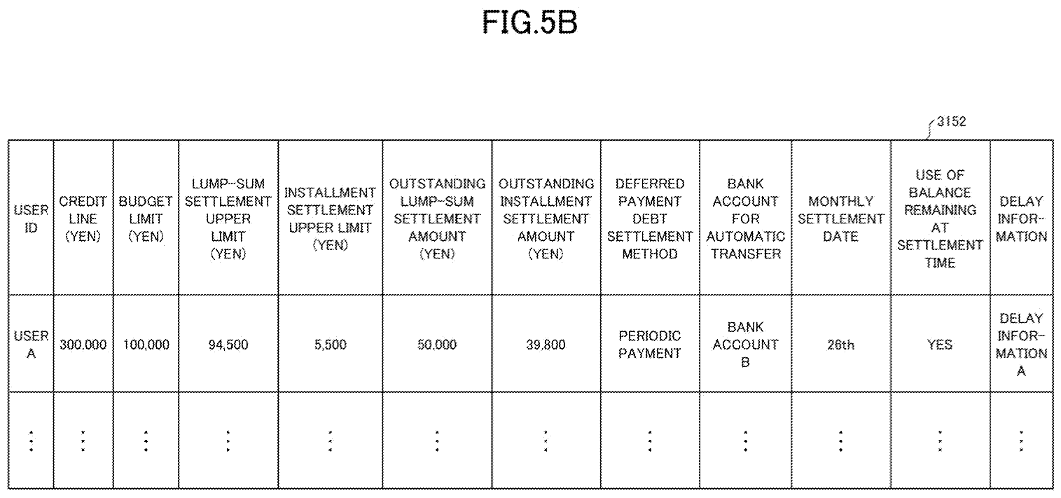

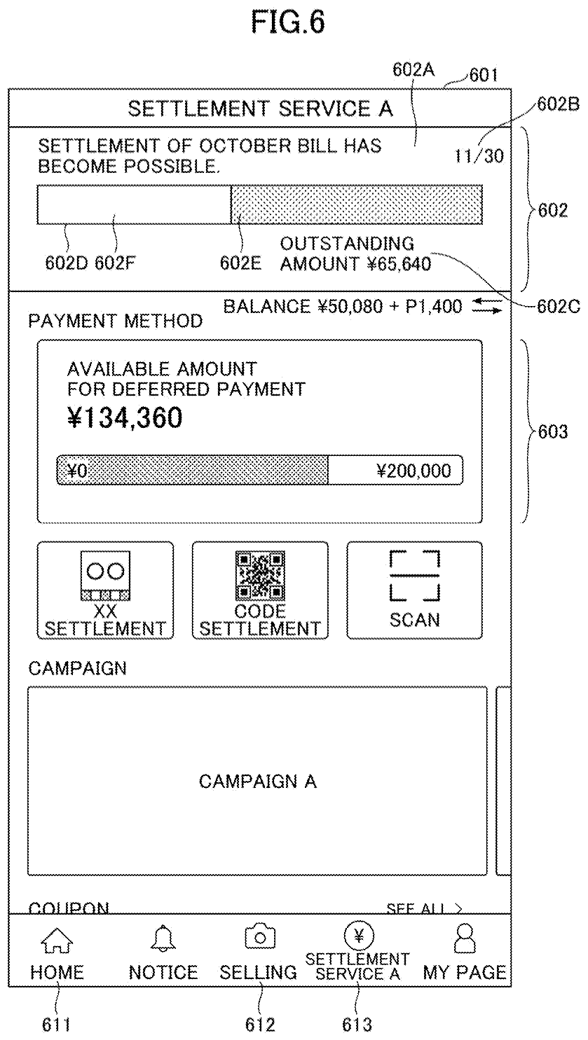

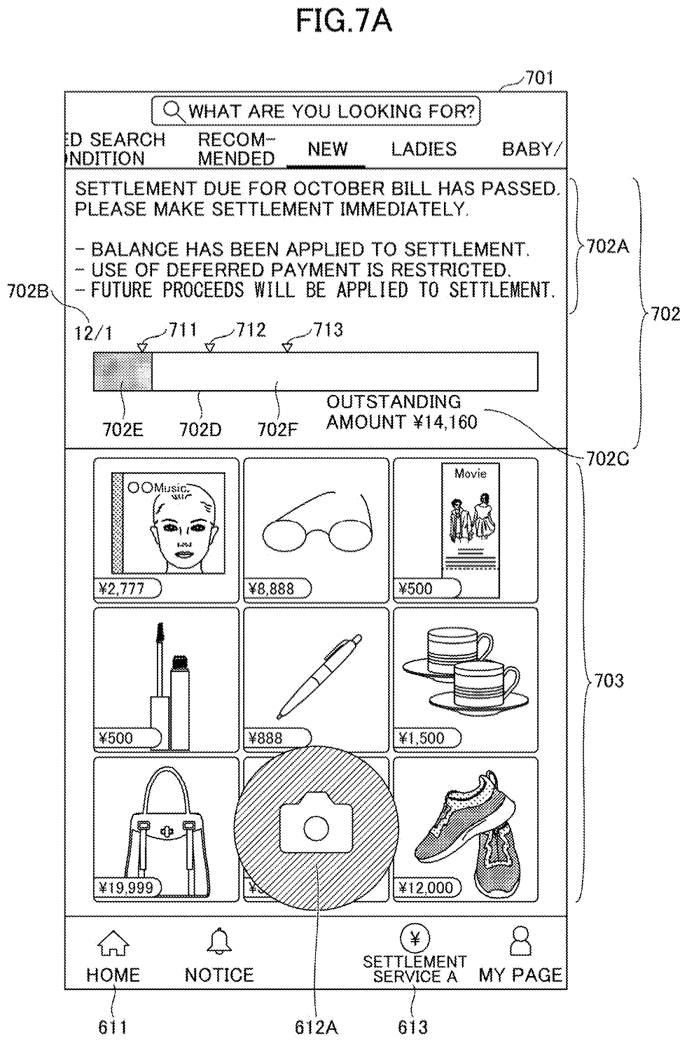

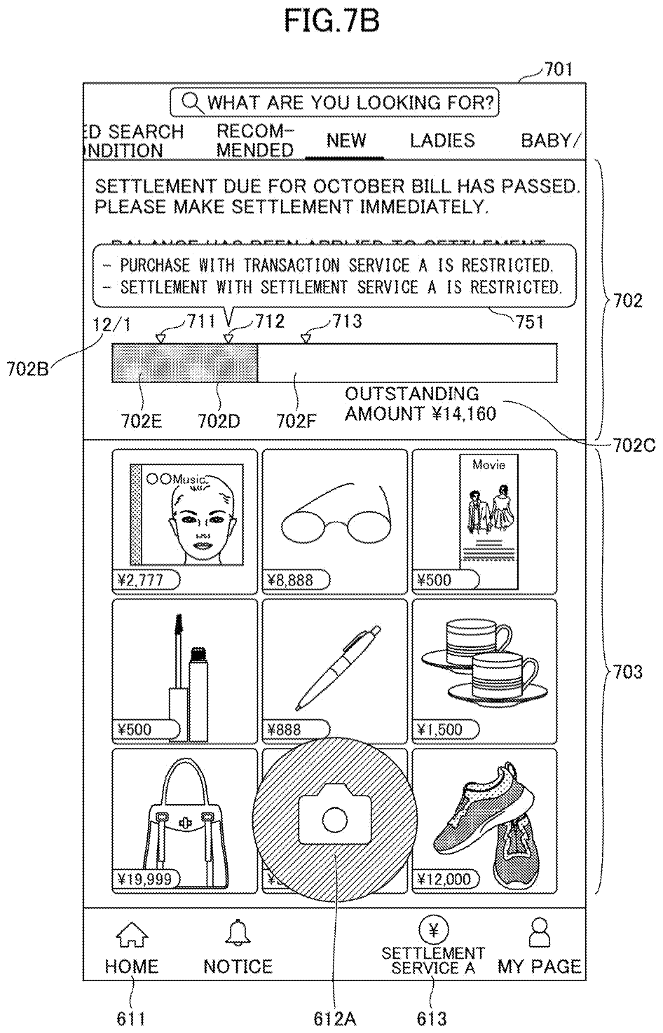

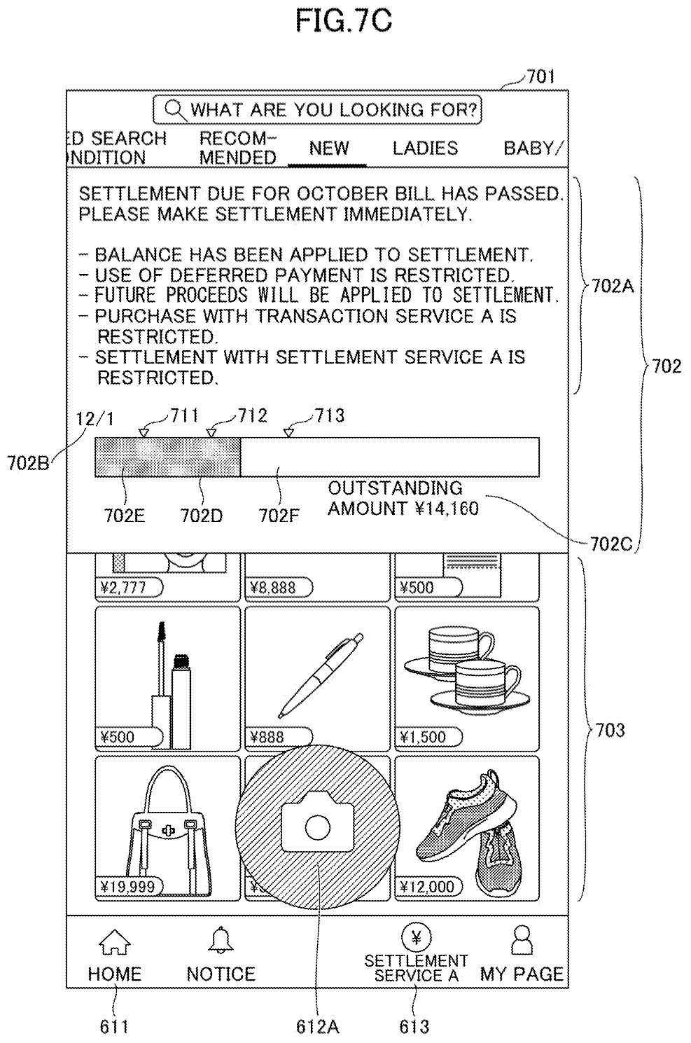

Examples of processes performed by the communication system 1 of the embodiment are described with reference to FIGS. 4 through 7C. FIG. 4 is a sequence chart illustrating an example of a process performed by the communication system 1 according to the embodiment. FIG. 5A illustrates an example of user information stored in the user information storage 3151 according to the embodiment. FIG. 5B illustrates an example of deferred payment information stored in the deferred payment information storage 3152 according to the embodiment. FIG. 6, FIG. 7A, FIG. 7B, and FIG. 7C illustrate examples of display screens of the terminal 120 according to the embodiment. Here, it is assumed that the terminal 120A is authenticated by the server 110 using an account of a user A to communicate with the server 110.

At step S1, the terminal 120A receives an operation from the user A to make settings for a deferred payment service provided by the server 110. Here, the terminal 120A may enable the user A to select a deferred payment debt settlement method (payment method) from, for example, balance payment, account transfer, and convenience store/ATM payment. The balance payment is a method of settling debt using the balance of the user A. Examples of balance payment may include periodic balance payment and pay-as-you-go balance payment.

In the periodic balance payment, for example, on a monthly settlement date (withdrawal date) specified by the user, a deferred payment settlement amount of the user A on the settlement date is withdrawn from the balance of the user A in the settlement service provided by server 110.

When “Use of Balance Remaining at Settlement Time” is set to “Yes” and the balance of the user A in the settlement service is insufficient, a part of the settlement amount is transferred to the balance from a deposit account for automatic transfer, and the settlement amount is withdrawn from the balance. Also, when “Use of Balance Remaining at Settlement Time” is set to “No”, the entire settlement amount is transferred to the balance from the deposit account for automatic transfer, and then the settlement amount is withdrawn from the balance.

The deposit account for automatic transfer may be the same deposit account as a deposit account for manual transfer that is recorded in the user information storage 3151 of FIG. 5A described later, or may be a different deposit account. The financial institution server 140 may be operated by a financial institution that manages the deposit account for automatic transfer. The server 110 may enable selecting the monthly settlement date from multiple predetermined dates (e.g., 11th, 16th, and 26th).

In the pay-as-you-go balance payment, balance payment is made in response to an operation from the user A. In this case, in response to the operation of the user A, the deferred payment settlement amount of the user A may be withdrawn from the balance of the user A.

The account transfer (automatic account transfer, automatic withdrawal) is a settlement method where a settlement amount is automatically withdrawn each month from a deposit account of a financial institution such as a bank that is specified by the user A and handles deposits and savings. The convenience store/ATM payment is a settlement method where settlement is made with cash at, for example, a convenience store.

Next, the terminal 120A sends a deferred payment service setting request to the server 110 (step S2). The deferred payment service setting request may include a user ID of the user A. Also, the server 110 may obtain the user ID of the terminal 120A based on a communication session ID of the request received from the terminal 120A.

Next, the server 110 refers to the user information storage 3151 and determines the credit line, which indicates the upper limit of debt that the user A can use for deferred payment, based on, for example, the deferred payment method of the user A and personal information of the user A (step S3).

In the example of FIG. 5A, the user information storage 3151 stores balance, a bank account (deposit account), action history, and personal information in association with the user ID. The user ID is identification information of the user.

The balance indicates values that the user can use for settlement with the settlement service provided by the server 110. In the example of FIG. 5A, the balance includes credit balance (yen), sales proceeds (yen), and points. The credit balance is the balance of an electronic value deposited via, for example, a bank, a credit card, or a cash register of a store. The sales proceeds indicate the total amount of money obtained by subtracting commissions from the prices of products sold by the user using the transaction service provided by the server 110.

The points indicate points given by the server 110 to the user and can be used for settlement with the settlement service provided by the server 110 and deferred payment settlement. For example, one point may be used to pay one yen. In the example of FIG. 5A, the balance that the user A can use for settlement is 8,600 yen that is the sum of 7,000 yen in the credit balance, 1,500 yen in the sales proceeds, and 100 yen in the points. Although not illustrated in FIG. 5A, credit (credit score) may also be associated with the user ID.

The bank account is, for example, a deposit account of the user in a financial institution having a partnership with a business operator operating the server 110. The deposit account (deposit account for manual transfer) is registered by the user and can be used to transfer money from the deposit balance to the balance in response to an operation of the user.

The action history is action history of the user. The action history may include, for example, action history in the settlement service provided by the server 110 and action history in the electronic commerce service provided by the server 110. The action history in the settlement service may include history of balance that includes the history of deposits and withdrawals in relation to settlement, remittance between individuals, and transfer of money from a deposit account of a financial institution to the balance. The action history in the settlement service may also include, for example, the history of deferred payment that includes the history of settlement by deferred payment and the history of settlement of debt such as deferred payment.

The action history in the electronic commerce service provided by the server 110 may include, for example, the history of buying and selling goods using the electronic commerce service.

The personal information is personal information of the user. The personal information may include, for example, a name, an address, a birth date, an annual income, a family structure, owned house, and place of employment (occupation).

Next, the server 110 records the determined credit line and information on deferred payment set by the user A in the deferred payment information storage 3152 (step S4). The credit line may be updated at predetermined intervals or at predetermined timing.

In the example of FIG. 5B, deferred payment information is recorded in the deferred payment information storage 3152 in association with the user ID. The deferred payment information is information related to the deferred payment service provided by the server 110.

In the example of FIG. 5B, the deferred payment information includes credit line of the user, budget limit, lump-sum settlement upper limit, installment payment upper limit (minimum payment), outstanding lump-sum settlement amount, outstanding installment settlement amount, deferred payment debt settlement method, deposit account (bank account) for automatic transfer, monthly settlement date, use of balance remaining at settlement time, and delay information (example of “information related to settlement of debt of user”).

The budget limit is the upper limit of the amount to be settled (paid or repaid) with the deferred payment service at each settlement date (for example, the end of each month). The budget limit is the sum of the lump-sum settlement upper limit and the installment settlement upper limit. The lump-sum settlement upper limit and the installment settlement upper limit may be set, for example, by the user.

The lump-sum settlement upper limit is the upper limit of money (monthly clearing) that is settled in a lump sum on the settlement date (for example, the end of the next month). The installment settlement upper limit is the upper limit of the total amount of money settled by revolving payment and installment payment on each settlement date (for example, the end of each month).

The outstanding lump-sum settlement amount is the remaining amount (debt) of unsettled lump-sum payment (principal). The outstanding installment settlement amount is the remaining amount (debt) of unsettled installment payment (principal).

In the revolving payment as a type of installment plan, for example, when the outstanding amount of the revolving payment on the settlement date is greater than or equal to the installment settlement upper limit set for the user, a fixed amount corresponding to the installment settlement upper limit is withdrawn from the balance of the user. Also, when the outstanding amount of the revolving payment on the next settlement date is less than the installment settlement upper limit set for the user, the outstanding amount is withdrawn from the balance of the user. The outstanding amount may include the principal and the interest rate fee.

In the installment payment as a type of installment plan, for each product purchased by the installment payment, a fixed amount obtained by dividing the price of the product by the number of payments specified by the user is withdrawn from the balance of the user on each settlement date. The installment plan may be specified before the purchase of a product or after the purchase of a product.

The deferred payment debt settlement method, the deposit account for automatic transfer, the monthly settlement date, and the use of balance remaining at settlement time may be specified by the user at step S1.

The delay information is information on debt whose settlement deadline has passed. The delay information may include, for example, a pair of the settlement deadline and the amount of debt that has not been settled by the settlement deadline.

The server 110 may determine the settlement deadline of debt based on the date and time when the user used deferred payment. In this case, the server 110 may set the settlement deadline of debt at the last day (the end of month) of the month following the month to which the day on which the user used the deferred payment belongs.

Next, the terminal 120A receives an operation for purchasing a product A using deferred payment from the user A. Here, the terminal 120A may perform settlement using, for example, a two-dimensional code and near-field communications in a state where deferred payment is specified in advance by the user A (step S5).

Next, the terminal 120A sends a deferred payment use request to the server 110 (step S6). The deferred payment use request may include, for example, a user ID of the user A, a payment amount, information indicating the product A, and information indicating a deferred payment method. The information indicating the deferred payment method may be set in the server 110 before this step at, for example, step S4 described above.

Next, the server 110 makes settlement for the product A by using the deferred payment service (step S7). At this step, the server 110 records information such as a deferred payment debt of the user A in the deferred payment information storage 3152. The server 110 may be configured to convert a lump-sum payment debt to an installment payment debt and vice versa according to an operation of the user A.

Next, the server 110 sends, to the terminal 120A, information for causing the terminal 120A to display the status of debts of the user A (step S8). When receiving an operation to display a display screen for using services provided by the server 110, the terminal 120A sends an information acquisition request including the user ID of the user A to the server 110. Then, the server 110 may send the delay information of the user A stored in the deferred payment information storage 3152 to the terminal 120A. Also, the server 110 may generate an image such as an after-delay banner described later based on the delay information of the user A, and send the generated image to the terminal 120A.

Next, the terminal 120A displays the status of debts of the user A such as deferred payment debts on the screen based on the information received from the server 110 (step S9).

In the example of FIG. 6, the terminal 120A displays a settlement service A display screen 601 including a display region 602 (which may also be referred to as a “before-delay banner”) displaying information related to settlement of a before-delay debt, a display region 603 displaying information related to settlement using the settlement service A, a “HOME” button 611, a “SELLING” button 612, and a “SETTLEMENT SERVICE A” button 613.

The display region 603 displaying information related to settlement using the settlement service A includes an available amount for deferred payment that is a difference between the upper limit of deferred payment and the used amount of the current month.

When the “HOME” button 611 is pressed, the terminal 120A displays a top screen of an interpersonal transaction service. When the “SELLING” button 612 is pressed, the terminal 120A displays a screen (selling screen) for registering information on an item to be sold (or put up) in the interpersonal transaction service by the user A. When the “SETTLEMENT SERVICE A” button 613 is pressed, the terminal 120A displays the settlement service A display screen 601 as illustrated in FIG. 6.

In the example of FIG. 6, the display region 602, for displaying information related to settlement of a before-delay debt, displays a message 602A indicating that a debt can be settled currently, a settlement deadline 602B of the debt, an amount 602C that needs to be settled by the user A by the settlement deadline 602B, and a gauge 602D indicating time (the number of days) remaining until the settlement deadline.

The gauge 602D includes a region 602F that indicates time elapsed from the start of a period where the debt can be settled to the present and a region 602E that indicates remaining time from the present to the settlement deadline 602B. When the amount 602C that the user A needs to settle by the settlement deadline 602B is not 0 yen (if the debt for the current month has not been paid off), the region 602F expands to the right as time elapses, and the region 602E shrinks by the amount by which the region 602F expands. Then, when the settlement deadline 602B comes (for example, at 24:00 of the current day or 12 midnight of the next day), the terminal 120A displays the gauge 602D in which the region 602F occupies the entire range and the region 602E is not present.

FIG. 7A illustrates an example of a top screen 701 of the interpersonal transaction service that is displayed when the settlement of a debt is delayed. When the settlement is delayed, the terminal 120A displays a display region 702 (which may also be referred to as an “after-delay banner”) for displaying information related to settlement of an after-delay debt instead of the display region 602 for displaying information related to a before-delay debt even on the settlement service A display screen 601 of FIG. 6. Here, the after-delay banner is displayed in a display mode corresponding to the delay information of the user A. The display mode includes, for example, at least one of a size, a color, brightness, a shape, and a display position.

The display mode of the after-delay banner may be determined by the server 110 or the terminal 120A based on, for example, the degree of delay from the settlement deadline, the amount of delayed debt, and the credit of the user A. The degree of delay from the settlement deadline may be determined based on, for example, the number of days that has passed from the settlement deadline to the present. The amount of delayed debt may include a delay charge (delay interest).

The server 110 may calculate the credit of the user A based on, for example, the action history and the personal information of the user A. In this case, for example, the server 110 may decrease the value of the credit of the user A as the number of times the settlement of debts is delayed in the action history of the user A increases. Also, for example, the server 110A may decrease the value of the credit of the user A as the number of times items are put up in the transaction service and sold by the user A (i.e., the number of items purchased by other users) in the action history of the user A decreases.

Also, for example, the server 110 or the terminal 120A may display the after-delay banner in a display mode that is more easily noticeable by the user as the degree of delay from the settlement deadline increases, the amount of delayed debt increases, and/or the credit of the user A becomes lower. For example, display modes easily noticeable by the user may include a display mode where the area of the after-delay banner is increased, a display mode where a vivid color such as red is used as the background color, a display mode where the brightness is increased, a display mode where the after-delay banner is displayed in a star shape, and a display mode where the after-delay banner is displayed in the center of the screen. The server 110 may determine that the settlement of a debt is delayed (in arrears or delinquent) when the amount 602C that the user A needs to settle by the settlement deadline 602B is not 0 yen and the current date and time pass the settlement deadline 602B.

In the example of FIG. 7A, the after-delay banner display region 702 displays a message 702A including a reminder requesting to make settlement and information related to restrictions currently applied to the user A in various services provided by the server 110, a delay starting date 702B indicating the date at which the settlement deadline of a debt has passed (the day after the settlement deadline), an amount 702C of a debt (the amount of a delayed debt) that the user A needs to settle immediately, and a gauge 702D indicating the passage of time (the number of days) from the delay starting date 702B.

The gauge 702D includes a region 702E indicating time elapsed from the delay starting date 702B to the present and another region 702F. When the delayed debt has not been paid off, the region 702E expands to the right as time elapses, and the region 702F shrinks by the amount by which the region 702E expands. When the number of days passed from the delay starting date 702B to the present exceeds a threshold, the terminal 120A displays the gauge 702D in which the region 702E occupies the entire range and the region 702F is not present. The terminal 120A may also display elapsed time (the number of days) from the delay starting date.

In the example of FIG. 7A, a mark 711 indicating a first time limit, a mark 712 indicating a second time limit, and a mark 713 indicating a third time limit from the delay starting date 702B are provided on the gauge 702D. In the example of FIG. 7A, the elapsed time from the delay starting date 702B to the present has exceeded the first time limit as indicated by the region 702E. For this reason, the server 110 applies restrictions to the user A. In this example, as indicated by the message 702A, the balance of the user A in the settlement service has been applied to the settlement, new settlement by deferred payment is restricted, and future proceeds of the user A in the transaction service will be applied to the settlement.

When the user A performs an operation to increase the area of an object requesting the settlement of a delayed debt, information on restrictions applied to the user A is displayed according to the degree of delay corresponding to the increased area of the region 702E. In this case, the object may be, for example, the after-delay banner, a “SELLING” button 612A described later, or the region 702E. For example, when the region 702E in FIG. 7A is swiped to the right by the user A, the terminal 120A expands the region 702E to the right as illustrated in FIG. 7B. Here, “swiping” indicates, for example, an operation of sliding a finger while touching a touch panel screen.

Then, as illustrated in FIG. 7B, when the region 702E expanded to the right by swiping exceeds the position of the mark 712, the terminal 120A displays a message 751 indicating restrictions that are applied to the user A when the elapsed time from the delay starting date 702B exceeds the second time limit. In the example of FIG. 7B, the message 751 indicates that, when the delay exceeds the second time limit, purchases by the user A with the transaction service provided by the server 110 are restricted and new settlement by the user A with the settlement service provided by the server 110 is restricted.

Also, when the region 702E expanded by swiping exceeds the position of the mark 713, the terminal 120A displays restrictions that are applied to the user A when the elapsed time from the delay starting date 702B exceeds the third time limit. Then, when the user A ends the swiping operation by moving the finger away from the touch panel screen, the terminal 120A may shrink the expanded region 702E to its original size and restore the top screen 701 to the original state as illustrated in FIG. 7A.

When the “HOME” button 611 in FIG. 6 or FIG. 7A is pressed, the terminal 120A displays the top screen 701 of the interpersonal transaction service illustrated in FIG. 7A.

As illustrated in FIG. 7A, the top screen of the interpersonal transaction service includes an item list 703 that is a list of items (or products) being sold in the interpersonal transaction service provided by the server 110, the “HOME” button 611, and the “SETTLEMENT SERVICE A” button 613.

In the example of FIG. 7A, when the settlement of a debt is delayed, on the top screen of the interpersonal transaction service, the item list 703 (which is an example of a “display screen for using a service provided by the information processing apparatus”) of items being sold using the interpersonal transaction service is shifted (or moved) downward by an amount corresponding to the after-delay banner display region 702. Alternatively, the after-delay banner may be superposed on the item list 703. Also, as illustrated in FIG. 7C, the area of the after-delay banner display region 702 may be increased as the degree of delay increases. In other words, the area of the item list 703 may be decreased as the after-delay banner display region 702 increases. With this configuration, the user needs to hide or shrink the after-delay banner display region 702 to increase the area used for the interpersonal transaction service. This in turn makes it possible to facilitate the settlement of debts and increase the chance of collecting debts. Also, displaying the after-delay banner display region 702 on, for example, a top screen can be applied not only to the interpersonal transaction service but also to any service provided by the server 110. In the example of FIG. 7C, because the delay in the settlement of the debt is greater compared to the example of FIG. 7A, the area of the after-delay banner display region 702 is larger, and the area of the item list 703 of items being sold using the interpersonal transaction service is smaller. Also, the item list 703 may be shifted downward by an amount corresponding to the after-delay banner display region 702.

Also, when the settlement is delayed, similarly to the after-delay banner described above, the “SELLING” button 612 may be displayed in a display mode corresponding to the delay information of the user A. In the example of FIG. 7A, a “SELLING” button 612A, which is obtained by enlarging the “SELLING” button 612 and has a red background, is displayed. This makes it possible to encourage the user A to sell items and increase the chance of collecting debts with the sales profits (proceeds) of the sold items.

When the settlement is not delayed, the terminal 120A may not display the after-delay banner on the top screen of the interpersonal transaction service. In this case, the terminal 120A may display, instead of the after-delay banner, the item list 703 of items being sold using the interpersonal transaction service provided by the server 110 by shifting the item list 703 upward. Also, the terminal 120A may display the before-delay banner instead of the after-delay banner. When the settlement is not delayed, the terminal 120A displays the normal “SELLING” button 612 as illustrated in FIG. 6 instead of the enlarged “SELLING” button 612A.

Next, the terminal 120A receives an operation from the user A to settle the deferred payment debt (step S10). When the before-delay banner is pressed by the user A, the terminal 120A may display a display screen (a before-delay debt settlement screen) for receiving an operation to settle an undelayed debt of the user A.

Also, when the after-delay banner is pressed by the user A, the terminal 120A may display a display screen (an after-delay debt settlement screen) for receiving an operation to settle a delayed debt of the user A. When receiving an operation to settle a debt by, for example, the convenience store/ATM payment from the user A on the debt settlement screen, the terminal 120A may report the reception of the operation to the server 110. Then, the terminal 120A may display information that is issued by the server 110 and necessary to settle the debt at, for example, a convenience store on the screen. The information may be, for example, a bar code or a two-dimensional code including the identification information of the user A or the identification information of delay information of the user A.

Next, the server 110 settles the deferred payment debt of the user A (step S11). Here, when the debt is settled using the balance of the user A, the server 110 reduces the balance of the user A recorded in the user information storage 3151 by an amount corresponding to the settled debt.

When a before-delay debt is settled, the server 110 reduces the outstanding lump-sum settlement amount and the outstanding installment settlement amount of the user A recorded in the deferred payment information storage 3152 by an amount corresponding to the amount of debt settled by the user A. Also, the server 110 may record the history of the settlement of deferred payment debts in the action history of the user A in the user information storage 3151.

Also, when an after-delay debt is settled, the server 110 reduces the amount of debt in the delay information of the user A recorded in the deferred payment information storage 3152 by an amount of the debt settled by the user A. If the amount of debt in the delay information of the user A becomes 0 yen as a result of this reduction, the terminal 120A does not display the after-delay banner thereafter.

Also, the server 110 may record the history of settlement of after-delay deferred payment debts in the action history of the user A in the user information storage 3151.

Examples of processes according to the above-described embodiment are described below. The following examples may be combined as necessary.

In a first example, when the user sets a periodic settlement method using a deposit account of the user as a debt settlement method of the user according to the embodiment, the before-delay banner and the after-delay banner are hidden or the display modes of the before-delay banner, the after-delay banner, and the “SELLING” button are changed. In the first example, the before-delay banner can be hidden when, for example, the debt is automatically settled on a predetermined settlement date. Also, for example, when the user sets a method for automatically transferring money from a deposit account of a bank to the balance of the user or for directly depositing money, it is considered that the user is willing to repay the debt. Therefore, in this case, the after-delay banner and the “SELLING” button may be displayed in display modes that are less noticeable.

At step S8 of FIG. 4, the server 110 sends, to the terminal 120A, the delay information of the user A stored in the deferred payment information storage 3152 and information on the deferred payment debt settlement method of the user A as information for causing the terminal 120A to display the status of debts of the user A.

Then, at step S9 of FIG. 4, the terminal 120A displays, on the screen, the status of debts of, for example, deferred payment made by the user A based on the information received from the server 110. When the user A has no delayed debt and the debt settlement method set by the user A is the pay-as-you-go balance payment or the convenience store/ATM payment, the terminal 120A displays the before-delay banner as described above. When the user A has no delayed debt and the debt settlement method set by the user A is the periodic balance payment or the account transfer, the terminal 120A does not display the before-delay banner.

With this method, when, for example, the user A having a deferred payment debt changes the debt settlement method from the pay-as-you-go balance payment or the convenience store/ATM payment to the periodic balance payment or the account transfer through a process similar to steps S1 through S3 of FIG. 4, the before-delay banner is hidden. Thus, by selecting a periodic settlement method using the deposit account of the user, the user is less likely to be bothered by the debt settlement deadline.

Also, when the user A has a delayed debt and the debt settlement method set by the user A is the pay-as-you-go balance payment or the convenience store/ATM payment, the terminal 120A displays the after-delay banner in a first display mode as described above. When the user A has a delayed debt and the debt settlement method set by the user A is the periodic balance payment or the account transfer, the terminal 120A does not display the after-delay banner or displays the after-delay banner in a second display mode corresponding to the periodic balance payment or the account transfer. In this case, the second display mode may be less noticeable to the user than the first display mode. When, for example, the periodic balance payment is set, the terminal 120A may display the after-delay banner in a display mode where the area of the after-delay banner is smaller compared to a case where the pay-as-you-go balance payment is set.

With this method, when, for example, the user A having a delayed deferred payment debt changes the debt settlement method from the pay-as-you-go balance payment or the convenience store/ATM payment to the periodic balance payment or the account transfer through a process similar to steps S1 through S3 of FIG. 4, the after-delay banner is displayed in a smaller size. For example, this method enables a user, who is willing to repay the debt and is thought to have delayed the settlement due to carelessness, to change the display mode of the after-delay banner and the “SELLING” button to a less noticeable display mode.

In a second example according to the embodiment, the after-delay banner is displayed on each of display screens for using various services provided by the server 110. For example, when the user delays the settlement of a debt, the second example makes it possible to request the user to settle the delayed debt when the user uses various services provided by the server 110.

The server 110 may display the after-delay banner on a screen displaying a list of other users for which predetermined relationships such as “friend” and “follow” are set by the user A in an SNS provided by the server 110. Also, the server 110 may display the after-delay banner on a screen (timeline) displaying a list of messages (posts) sent by the other users for which predetermined relationships are set by the user A in the SNS provided by the server 110.

Also, the server 110 may display the after-delay banner on a screen (talk room screen) chronologically displaying messages sent and received in a group including the user A and the other users in the SNS provided by the server 110. For example, the server 110 may superpose the after-delay banner on an input field for entering a message to be sent to the group. In this case, when a “close” button included in the after-delay banner is pressed by the user A, the server 110 may temporarily hide the after-delay banner and allow the user A to enter a message in the input field.

Also, the server 110 may send the after-delay banner to the group. For example, when a message addressed to the group is sent by the user A, the server 110 may send the after-delay banner using a chatbot function. In this case, the server 110 may send the after-delay banner together with information specifying that the after-delay banner is displayed only on the terminal 120A of the user A. This makes it possible to prevent other users in the group from knowing that the user A has delayed the settlement of debts.

The above embodiment is described using the settlement of a deferred payment debt as an example. However, the present invention is not limited to this example. More specifically, the debt may be any type of debt associated with the user. For example, the debt may be, but is not limited to, a loan from a business operator associated with the server 110.

An information processing method, an information processing apparatus, a storage medium, and an information processing terminal according to the embodiment are described above. However, the present invention is not limited to the specifically disclosed embodiment, and variations and modifications may be made without departing from the scope of the present invention.

What is claimed is:

1. A method performed by an information processing apparatus, the method comprising:
when settlement of a debt of a user is delayed, determining a display mode of a first object based on at least one of a degree of delay from a settlement deadline of the debt of the user, an amount of the debt whose settlement is delayed by the user, and a credit of the user; and
sending, to an information processing terminal, information for causing the information processing terminal to display the first object in the determined display mode.

2. The method as claimed in claim 1, wherein the display mode includes at least one of a size, a color, brightness, a shape, and a display position.

3. The method as claimed in claim 1, further comprising:
when periodic settlement using a deposit account of the user is set by the user as a settlement method of the debt of the user, sending, to the information processing terminal, information for causing the information processing terminal to hide the first object or change the display mode of the first object.

4. The method as claimed in claim 1, wherein the display mode is determined such that a display area of the first object is increased as the degree of delay from the settlement deadline of the debt of the user increases.

5. The method as claimed in claim 1, wherein the information sent to the information processing terminal causes the information processing terminal to
display both of a display screen for using a service provided by the information processing apparatus and the first object, or
display the display screen for using the service provided by the information processing apparatus at a position that is moved according to a region where the first object is displayed.

6. The method as claimed in claim 5, wherein
the service provided by the information processing apparatus is an electronic commerce service; and
the information sent to the information processing terminal also causes the information processing terminal to display a second object, which receives from the user an operation to sell an item using the electronic commerce service, in a display mode corresponding to information related to the settlement of the debt of the user.

7. The method as claimed in claim 1, further comprising:
when the user performs an operation to increase an area of the first object, sending, to the information processing terminal, information for causing the information processing terminal to display a restriction applied to the user depending on the degree of delay corresponding to the increased area of the first object.

8. An information processing apparatus, comprising:
a processor programmed to execute a process including when settlement of a debt of a user is delayed, determining a display mode of a first object based on at least one of a degree of delay from a settlement deadline of the debt of the user, an amount of the debt whose settlement is delayed by the user, and a credit of the user, and
sending, to an information processing terminal, information for causing the information processing terminal to display the first object in the determined display mode.

9. A non-transitory computer-readable storage medium storing a program for causing an information processing terminal to execute a process, the process including:
when settlement of a debt of a user is delayed, determining a display mode of a first object based on at least one of a degree of delay from a settlement deadline of the debt of the user, an amount of the debt whose settlement is delayed by the user, and a credit of the user; and
displaying the first object in the determined display mode.

10. The non-transitory computer-readable storage medium as claimed in claim 9, wherein the process further includes:
displaying a display screen for receiving an operation to settle the debt of the user in response to an operation on the first object.

11. The non-transitory computer-readable storage medium as claimed in claim 9, wherein the process further includes:
hiding the first object when the debt of the user is settled.
